(19) United States
(12) Patent Application Publication
(10) Pub. No.: US 2020/0014640 A1
(43) Pub. Date: Jan. 9, 2020

(54) COLLABORATIVE MESSAGING WITH NATURAL DELAYS

(71) Applicant: INTERNATIONAL BUSINESS MACHINES CORPORATION, ARMONK, NY (US)

(72) Inventors: Lisa Seacat DeLuca, Baltimore, MD (US); Clifford A. Pickover, Yorktown Heights, NY (US)

(21) Appl. No.: 16/028,482

(22) Filed: Jul. 6, 2018

(51) Int. Cl. H04L 12/58

(52) U.S. Cl. CPC H04L 51/046; G06N 99/005; H04L 51/043

(57) ABSTRACT

A method for collaborative messaging including natural delays includes receiving, by a computer, a message from a sender intended for a recipient using a collaborative messaging application, determining, by the computer, message characteristics, sender characteristics, and recipient characteristics, based on the determined message characteristics, sender characteristics, and recipient characteristics, dividing the message into one or more segments, based on the determined message characteristics, sender characteristics, recipient characteristics and segment size, determining a time delay for each of the one or more segments, and transmitting the message to the recipient one segment at a time, wherein successive segments are separated by the time delay corresponding to each segment.

### BACKGROUND

The present invention generally relates to the field of collaborative messaging systems, and more particularly to collaborative messaging including natural delays.

Collaborative messaging systems have become widely adopted across both work and personal environments. Currently, many organizations are implementing collaborative messaging applications to make work across teams more efficient. Particularly, collaborative messaging applications emphasize and enable teamwork by facilitating real-time communication and distribution of information between team members.

### SUMMARY

According to an embodiment of the present disclosure, a method for collaborative messaging including natural delays includes receiving, by a computer, a message from a sender intended for a recipient using a collaborative messaging application, determining, by the computer, message characteristics, sender characteristics, and recipient characteristics, based on the determined message characteristics, sender characteristics, and recipient characteristics, dividing the message into one or more segments, based on the determined message characteristics, sender characteristics, recipient characteristics and segment size, determining a time delay for each of the one or more segments, and transmitting the message to the recipient one segment at a time, where successive segments are separated by the time delay corresponding to each segment.

According to another embodiment of the present disclosure, a computer system for collaborative messaging including natural delays includes one or more processors, one or more computer-readable memories, one or more computer-readable tangible storage devices, and program instructions stored on at least one of the one or more storage devices for execution by at least one of the one or more processors via at least one of the one or more memories, wherein the computer system is capable of performing a method including receiving, by a computer, a message from a sender intended for a recipient using a collaborative messaging application, determining, by the computer, message characteristics, sender characteristics, and recipient characteristics, based on the determined message characteristics, sender characteristics, and recipient characteristics, dividing the message into one or more segments, based on the determined message characteristics, sender characteristics, recipient characteristics and segment size, determining a time delay for each of the one or more segments, and transmitting the message to the recipient one segment at a time, where successive segments are separated by the time delay corresponding to each segment.

### BRIEF DESCRIPTION OF THE DRAWINGS

The following detailed description, given by way of example and not intended to limit the invention solely thereto, will best be appreciated in conjunction with the accompanying drawings, in which:

FIG. 1 is a block diagram illustrating a networked computer environment, according to an embodiment of the present disclosure;

FIG. 2 is a flowchart illustrating the steps of a method for collaborative messaging including natural delays, according to an embodiment of the present disclosure;

FIGS. 3A-3B illustrates an implementation of the method for collaborative messaging including natural delays, according to an embodiment of the present disclosure;

FIG. 4 is an example of a message sent using the method for collaborative messaging including natural delays, according to an embodiment of the present disclosure;

FIGS. 5 is a block diagram of internal and external components of computers and servers depicted in FIG. 1, according to an embodiment of the present disclosure;

FIG. 6 is a block diagram of an illustrative cloud computing environment including the computer system depicted in FIG. 1, according to an embodiment of the present disclosure; and

FIG. 7 is a block diagram of functional layers of the illustrative cloud computing environment of FIG. 6, according to an embodiment of the present disclosure.

The drawings are not necessarily to scale. The drawings are merely schematic representations, not intended to portray specific parameters of the invention. The drawings are intended to depict only typical embodiments of the invention. In the drawings, like numbering represents like elements.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. In the description, details of well-known features and techniques may be omitted to avoid unnecessarily obscuring the presented embodiments.

In the interest of not obscuring the presentation of embodiments of the present invention, in the following detailed description, some processing steps or operations that are known in the art may have been combined together for presentation and for illustration purposes and in some instances may have not been described in detail. In other instances, some processing steps or operations that are known in the art may not be described at all. It should be understood that the following description is rather focused on the distinctive features or elements of various embodiments of the present invention.

Users of collaborative messaging systems may often need to send a large portion of text to one or more recipients. However, copying and pasting text into an instant messaging application, and then sending it all at once would be unnatural and impersonal. For example, sending a multi-sentence message all at once may give the recipient(s) the idea that the message is canned, impersonal, and/or being sent to many different people. Still, in some cases, it can be useful and valid to copy and paste large portions of text to send to more than one recipient. For example, a user has reused a text cluster to send to multiple people trying to obtain involvement across a set of coworkers. In this example, it may be easier for the recipients to read segments of the text, one at a time, rather than a bigger piece containing a larger amount of information.

Embodiments of the present disclosure generally relate to the field of collaborative messaging systems, and more particularly to collaborative messaging including natural delays. The following described exemplary embodiments provide a system, method, and program product to, among other things, allow users to easily send large pieces of text to multiple individuals using different collaborative messaging applications or online collaboration software while mimicking a person's natural behavior such that the impression of a personalized conversation is given to the recipients. Therefore, the present embodiment has the capacity to improve the technical field of collaborative messaging systems by, at a minimum, allowing users to copy and paste large pieces of text simultaneously into different collaborative messaging applications and transmit such large pieces of text to multiple recipients in segments of the text spaced in a manner that mimics a user's natural behavior, thereby increasing the likelihood of engagement by the recipients by hiding the impersonal technical disadvantages associated with the traditional overwhelming experience that can happen with large copy and paste delivery of messages.

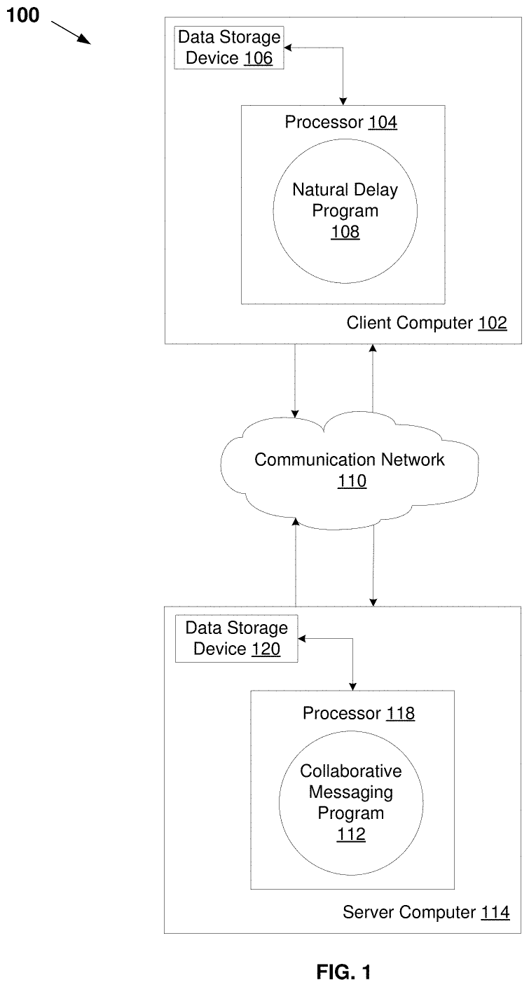

Referring now to FIG. 1, an exemplary networked computer environment 100 is depicted, according to an embodiment of the present disclosure. The networked computer environment 100 may include a client computer 102 with a processor 104 and a data storage device 106 that is enabled to run a natural delay program 108. The networked computer environment 100 may also include a server computer 114 and a communication network 110. The networked computer environment 100 may include a plurality of client computers 102 and server computers 114, only one of which is shown. The communication network 110 may include various types of communication networks, such as a wide area network (WAN), local area network (LAN), a telecommunication network, a wireless network, a public switched network and/or a satellite network. It should be appreciated that FIG. 1 provides only an illustration of one implementation and does not imply any limitations with regard to the environments in which different embodiments may be implemented. Many modifications to the depicted environments may be made based on design and implementation requirements.

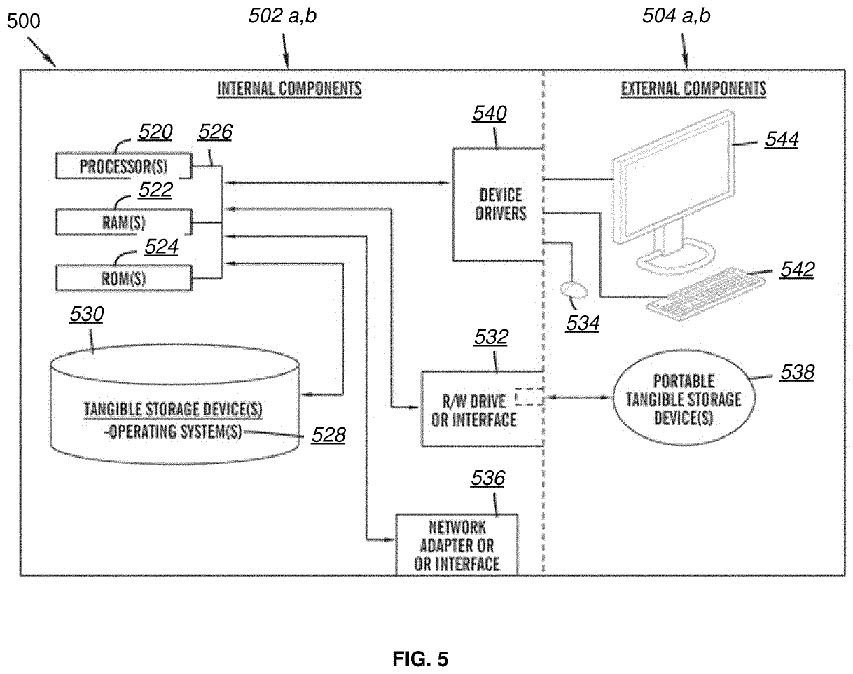

The client computer 102 may communicate with a collaborative messaging program 112 running on server computer 114 via the communications network 110. The communication network 110 may include connections, such as wire, wireless communication links, or fiber optic cables. As will be discussed with reference to FIG. 5, server computer 114 may include internal components 502a and external components 504a, respectively, and client computer 102 may include internal components 502b and external components 504b, respectively. Client computer 102 may be, for example, a mobile device, a telephone (including smartphones), a personal digital assistant, a netbook, a laptop computer, a tablet computer, a desktop computer, or any type of computing devices capable of accessing a network.

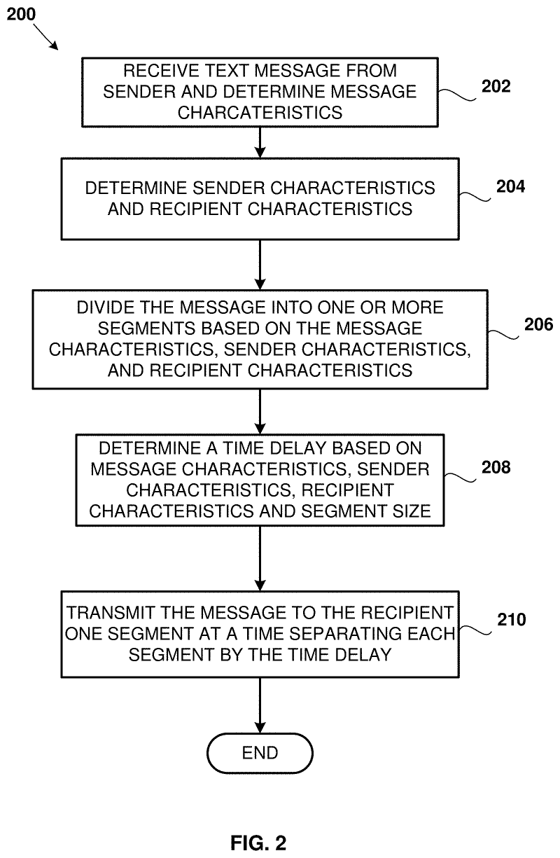

Referring now to FIG. 2, a flowchart 200 illustrating the steps of a method for collaborative messaging including natural delays is shown, according to an embodiment of the present disclosure. In this embodiment, a user (sender) selects a text (not shown) to share with one or more recipients using a collaborative messaging application, such that the collaborative messaging program 112 shown in FIG. 1. The collaborative messaging application may include any known personal or business collaborative messaging application such as, for example, IBM Sametime®, Slack®, AOL Instant Messenger®, Facebook Messenger®, Google Hangouts®, Instagram Direct Messaging®, and Apple iMessage®.

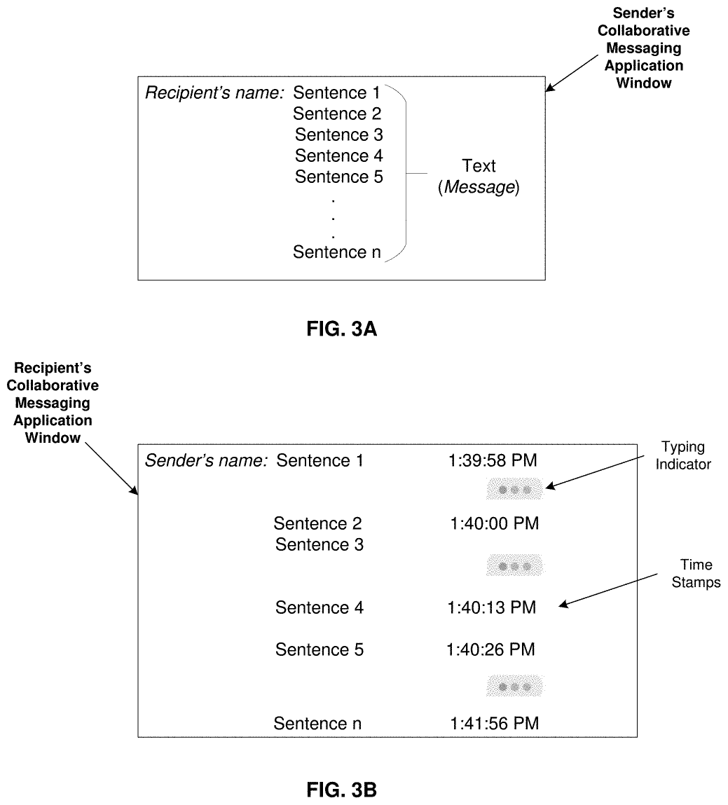

In this embodiment, the user copies and pastes the selected text into a window of the collaborative messaging application, as illustrated in FIG. 3A. It should be noted that the text can be pasted into one or more windows associated with different collaborative messaging applications depending on the target number of recipients. In some embodiments, the text may be copied from a source not created by the user (e.g., an online newspaper article or images). In other embodiments the user may type or dictate the text directly into the collaborative messaging application window(s). The user (hereinafter referred to as “sender”) proceeds to send a message containing the selected text to one or more recipients.

At step 202, the natural delay program 108 (FIG. 1) receives the message from the sender. Then, at step 204, the natural delay program 108 (FIG. 1) analyses the text within the message to determine message's characteristics. The message's characteristics determined by the natural delay program 108 (FIG. 1) generally include message size, message content, grammar and punctuation including the presence of periods, paragraph indicators, special characters, capital letters, URLs, media, and emoticons. In some embodiments, the natural delay program 108 (FIG. 1) may, by analyzing the message, determine language of the message (e.g., English or Italian), topic (as estimated by latent semantic indexing), mood, sender's cohort (e.g., recipient is a boss, friend, or family member), intent (e.g., the message may be promotional in nature for a particular cause, product, or service), location of recipient (e.g., home, office, or coffee shop), nature of device (e.g., cellphone, computer, etc.). The determined message's characteristics may be used to divide the message into one or more segments, as will be described in detailed below.

At step 204, the natural delay program 108 (FIG. 1) also determines sender's characteristics and recipient's characteristics. Specifically, the natural delay program 108 (FIG. 1) determines sender's characteristics and recipient's characteristics based on a corresponding user profile according to which a typing speed, typing habits, estimate of availability, a location, a device type or calendar entries are identified for the sender and recipient(s). According to an embodiment, the natural delay program 108 (FIG. 1) is capable of determining how busy the recipient appears to be by estimating the recipient's availability based on the recipient's calendar, the recipient currently typing to other recipients, the recipient's reply (such as “I′m in a meeting”), the recipient's active typing to the sender, the recipient's location, the recipient's calendar entry indicating a meeting, etc. It should be noted that, the instant messaging activity may be part of a group chat (involving two or more users) including social media applications in which a sender and a recipient are engaged in a conversation, chat bots, or in advertising.

At step 206, the natural delay program 108 (FIG. 1) automatically divides the text message into one or more segments based on the determined message's characteristics, sender's characteristics and recipient's characteristics. As illustrated in FIG. 3B, the natural delay program 108 (FIG. 1) divides the text in segments including one or more sentences of the text message based on the determined message's characteristics, sender's characteristics and recipient's characteristics. In this particular embodiment, the first segment includes Sentence 1 and the second segment includes Sentence 2 and Sentence 3 of the text.

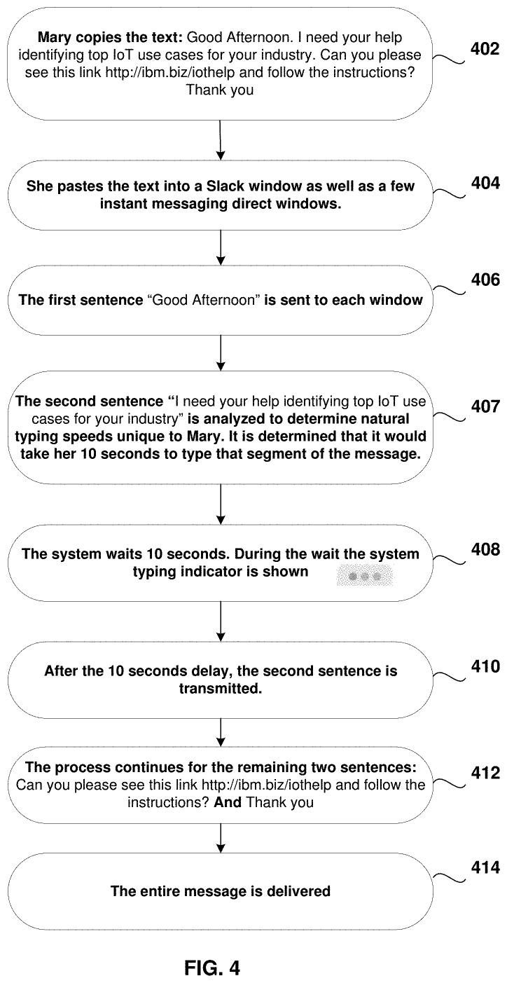

Another example is shown in FIG. 4, in this example an employee (Mary) copies a text requesting help with a determined topic at step 402. Mary pastes the following text at step 404 into several collaborative messaging applications: “Good Afternoon. I need your help identifying top IoT use cases for your industry. Can you please see this link http://ibm.biz/iothelp and follow the instructions? Thank you.”

Based on the determined message's characteristics, sender's characteristics and recipient's characteristics, the natural delay program 108 (FIG. 1) divides the text in four segments:

First segment : Good Afternoon.

Second segment: I need your help identifying top IoT use cases for your industry.

Third segment: Can you please see this link http://ibm.biz/iothelp and follow the instructions?

Fourth segment: Thank you.

It should be noted that, in some embodiments, the natural delay program 108 (FIG. 1) may ask the sender if he/she wishes to transmit the message segment by segment or all at once. In embodiments in which the sender selects to send the message all at once, the process ends.

With continued reference to FIG. 2, based on the message's characteristics, sender's characteristics, recipient's characteristics and estimated segment size, the natural delay program 108 (FIG. 1) determines a time delay at step 208. Specifically, the time delay indicates an amount of time based on which the one or more segments of the message can be separated during transmission to give the impression of a natural conversation. The determined time delay considers natural time delays or breaks caused by, for example, a length of the segment (e.g., word count), sender's typing speed, hesitation patterns, typing habits, or the type of device used to type the message (e.g., cellphone or computer).

It should be noted that segments of different size may have different time delays. For example, the time delay for a segment including only one word is shorter than the time delay for a segment including 50 words. For example, in FIG. 3B, based on the timestamps, the time delay between the first segment (Sentence 1) and the second segment (Sentence 2 and Sentence 3) is 2 seconds, since the second segment includes Sentence 2 and Sentence 3, a longer time delay is applied to account for the time it would take the sender to type both sentences. As such, the natural delay program 108 (FIG. 1) determines that the user may type both Sentence 2 and Sentence 3 in 13 seconds and applies this time delay before transmitting the third segment (Sentence 4), as illustrated in the figure.

Similarly, in the example of FIG. 4, the natural delay program 108 (FIG. 1) sends the first segment “Good Afternoon” to each collaborative messaging window at 406. At 407, the natural delay program 108 (FIG. 1) analyses the second segment “I need your help identifying top IoT use cases for your industry” to determine natural typing speeds unique to Mary. The natural delay program 108 (FIG. 1) determines it would take her 10 seconds to type the second segment of the message. Therefore, a time delay of 10 seconds is applied between the first and second segments of the message.

In some embodiments, the time delay may vary according to the type of device used to send the message, for example, the sender (e.g., Mary) may type slower or made more mistakes when using a small touch screen on a smartphone than when typing on a regular keyboard.

With continued reference to FIG. 2, the natural delay program 108 (FIG. 1) transmits the message to the recipient(s) one segment at a time separating each segment by the time delay at step 210, as illustrated in FIG. 3B. In some embodiments, the natural delay program 108 (FIG. 1) automatically provides a typing indicator (See FIG. 3B) visible to the recipient(s) during the duration of the time delay between transmission of successive segments to simulate the sender typing the next segment.

Specifically, a typing indicator icon, often displayed in instant messaging systems, is shown during the automatic insertion of delays and during the time delay interval. As shown in FIG. 3B, when Sentence 1 is sent, a time delay of 2 seconds is inserted before sending sentence 2. During those 2 seconds, even though the user is not typing a message, the natural delay program 108 (FIG. 1) displays the typing indicator.

In the example of FIG. 4, the natural delay program 108 (FIG. 1) applies the determined time delay at 408, and waits 10 seconds before transmitting the second segment of the message. During duration of the time delay the system typing indicator is shown. After the time delay of 10 seconds the natural delay program 108 (FIG. 1) transmits the second segment “I need your help identifying top IoT use cases for your industry.”. The process repeats for the third and fourth segments until the transmission of the message is completed.

In some embodiments, each time delay may include two component delays, for example, a first time delay value in which no typing indicator is displayed followed immediately by a second time delay value in which the typing indicator is displayed.

It should be noted that in embodiments in which the sender copies a text from an existing collaborative tool that has timestamps, the presence of the timestamps in the copied text can be interpreted as a signal of multiple segments and stripped out from reshare. Specifically, the time stamps in the copied text are an indication that there were intended breaks by the sender in the original message that could be preserved such that the message to be transmitted have a similar time delay based on the original delay of the timestamps.

In embodiments in which the recipient(s) begins to respond to one or more segments of the message before the entire message is sent, the natural delay program 108 (FIG. 1) automatically adjusts the time delay for the remaining (unsent) segments of the message. Specifically, the natural delay program 108 (FIG. 1) modifies the transmission of the message based on the presence of a recipient typing indicator. Alternatively, according to an embodiment, fragments of text, which are not part of the original message text, may be automatically inserted along with further time delays into the message, for example the text “Someone just came into my office, give me a minute.” may be inserted between segments of the message. This gives the communication a sense of greater naturalness, and also may allow the recipient to reflect in a useful manner on the text currently on the screen.

In some embodiments, the natural delay program 108 (FIG. 1) may wait after a first segment of the message is sent to provide a “sign of life” such as displaying the typing indicator or sending a response before transmitting the remaining queued segments.

In other embodiments, the natural delay program 108 (FIG. 1) may pause or cancel the transmission of a segment when the recipient responds before transmitting all segments of the message. In such cases, the sender may set a flag to indicate the importance of some or all segments of the message being delivered.

Based on the steps describe above, the natural delay program 108 (FIG. 1) is capable of learning the sender's transmission characteristics, learning the recipient's transmission characteristics, modeling time distribution between successive sends to learn various sender patterns, and modeling time distribution between successive sends to learn various recipient patterns. As such, the natural delay program 108 (FIG. 1) is continually training and learning from previous transmissions to adjust over time to be consistent with a sender's current patterns. For example, if the sender once typed at 50 words per minute, and currently types at 60 words per minute, the natural delay program 108 (FIG. 1) adjusts the time delay to reflect the new skill.

The previously described embodiments provide a method, system, and program product for automatically including natural time delays during transmission of large pieces of text via collaborative instant messaging applications such that the large piece of text can be delivered to one or more recipients one segment at a time providing a sense of greater naturalness or spontaneity to the recipient(s) while improving readability of the text message.

Referring now to FIG. 5, a block diagram 500 of internal and external components of computers depicted in FIG. 1 is shown according to an embodiment of the present disclosure. It should be appreciated that FIG. 5 provides only an illustration of one implementation and does not imply any limitations with regard to the environments in which different embodiments may be implemented. Many modifications to the depicted environments may be made based on design and implementation requirements.

Data processing system 502, 504 is representative of any electronic device capable of executing machine-readable program instructions. Data processing system 502, 504 may be representative of a smart phone, a computer system, PDA, or other electronic devices. Examples of computing systems, environments, and/or configurations that may represented by data processing system 502, 504 include, but are not limited to, personal computer systems, server computer systems, thin clients, thick clients, hand-held or laptop devices, multiprocessor systems, microprocessor-based systems, network PCs, minicomputer systems, and distributed cloud computing environments that include any of the above systems or devices.

The client computer 102 (FIG. 1) and server computer 114 (FIG. 1) may include respective sets of internal components 502a,b and external components 504a,b illustrated in FIG. 5. Each of the sets of internal components 502 include one or more processors 520, one or more computer-readable RAMs 522 and one or more computer-readable ROMs 524 on one or more buses 526, and one or more operating systems 528 and one or more computer-readable tangible storage devices 530. The natural delay program 108 (FIG. 1) and the collaborative messaging program 112 (FIG. 1) are stored on one or more of the respective computer-readable tangible storage devices 530 for execution by one or more of the respective processors 520 via one or more of the respective RAMs 522 (which typically include cache memory). In the embodiment illustrated in FIG. 5, each of the computer-readable tangible storage devices 530 is a magnetic disk storage device of an internal hard drive. Alternatively, each of the computer-readable tangible storage devices 530 is a semiconductor storage device such as ROM 524, EPROM, flash memory or any other computer-readable tangible storage device that can store a computer program and digital information.

Each set of internal components 502a,b also includes a R/W drive or interface 532 to read from and write to one or more portable computer-readable tangible storage devices 538 such as a CD-ROM, DVD, memory stick, magnetic tape, magnetic disk, optical disk or semiconductor storage device. Software programs, such as the first and second plurality of programs described above can be stored on one or more of the respective portable computer-readable tangible storage devices 538, read via the respective R/W drive or interface 532 and loaded into the respective hard drive 530.

Each set of internal components 502a,b also includes network adapters or interfaces 536 such as a TCP/IP adapter cards, wireless Wi-Fi interface cards, or 3G or 4G wireless interface cards or other wired or wireless communication links. The natural delay program 108 (FIG. 1) and the collaborative messaging program 112 (FIG. 1) can be downloaded to the client computer 102 (FIG. 1) and server computer 114 (FIG. 1) from an external computer via a network (for example, the Internet, a local area network or other, wide area network) and respective network adapters or interfaces 536. From the network adapters or interfaces 536, The natural delay program 108 (FIG. 1) and the collaborative messaging program 112 (FIG. 1) are loaded into the respective hard drive 530. The network may include copper wires, optical fibers, wireless transmission, routers, firewalls, switches, gateway computers and/or edge servers.

Each of the sets of external components 504a,b can include a computer display monitor 544, a keyboard 542, and a computer mouse 534. External components 504a,b can also include touch screens, virtual keyboards, touch pads, pointing devices, and other human interface devices. Each of the sets of internal components 502a,b also includes device drivers 540 to interface to computer display monitor 544, keyboard 542 and computer mouse 534. The device drivers 540, R/W drive or interface 532 and network adapter or interface 536 comprise hardware and software (stored in storage device 530 and/or ROM 524).

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

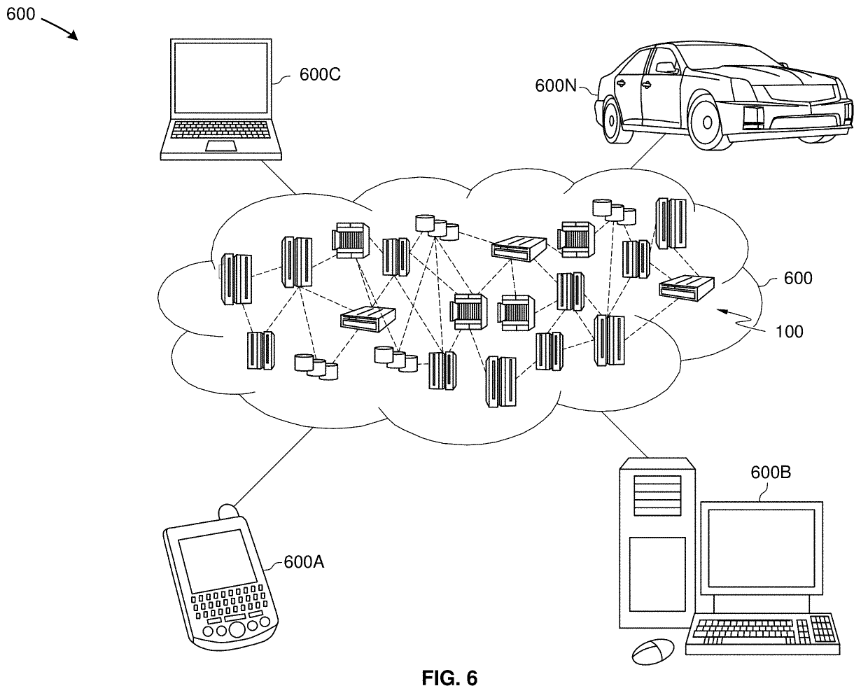

Referring now to FIG. 6, illustrative cloud computing environment 600 is depicted. As shown, cloud computing environment 600 comprises one or more cloud computing nodes 100 with which local computing devices used by cloud consumers, such as, for example, personal digital assistant (PDA) or cellular telephone 600A, desktop computer 600B, laptop computer 600C, and/or automobile computer system 600N may communicate. Nodes 100 may communicate with one another. They may be grouped (not shown) physically or virtually, in one or more networks, such as Private, Community, Public, or Hybrid clouds as described hereinabove, or a combination thereof. This allows cloud computing environment 600 to offer infrastructure, platforms and/or software as services for which a cloud consumer does not need to maintain resources on a local computing device. It is understood that the types of computing devices 600A-N shown in FIG. 6 are intended to be illustrative only and that computing nodes 100 and cloud computing environment 600 can communicate with any type of computerized device over any type of network and/or network addressable connection (e.g., using a web browser).

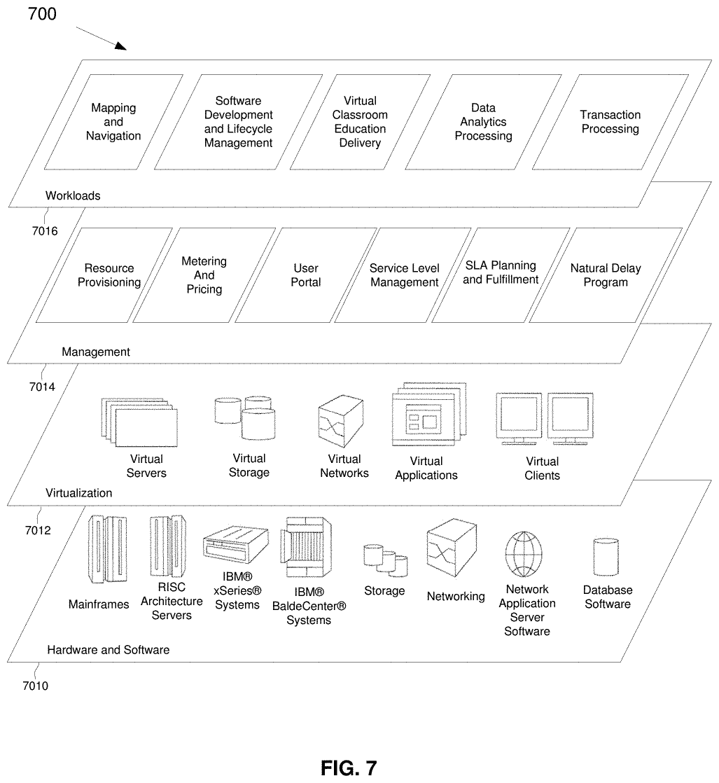

Referring now to FIG. 7, a set of functional abstraction layers 700 provided by cloud computing environment 600 (FIG. 6) is shown. It should be understood in advance that the components, layers, and functions shown in FIG. 7 are intended to be illustrative only and embodiments of the invention are not limited thereto. As depicted, the following layers and corresponding functions are provided:

Hardware and software layer 7010 includes hardware and software components. Examples of hardware components include: mainframes; RISC (Reduced Instruction Set Computer) architecture-based servers; storage devices; networks and networking components. In some embodiments, software components include network application server software.

Virtualization layer 7012 provides an abstraction layer from which the following examples of virtual entities may be provided: virtual servers; virtual storage; virtual networks, including virtual private networks; virtual applications and operating systems; and virtual clients.

In one example, management layer 7014 may provide the functions described below. Resource provisioning provides dynamic procurement of computing resources and other resources that are utilized to perform tasks within the cloud computing environment. Metering and Pricing provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal provides access to the cloud computing environment for consumers and system administrators. Service level management provides cloud computing resource allocation and management such that required service levels are met. Service Level Agreement (SLA) planning and fulfillment provide pre-arrangement for, and procurement of, cloud computing resources for which a future requirement is anticipated in accordance with an SLA. A program for collaborative messaging with natural delays.

Workloads layer 7016 provides examples of functionality for which the cloud computing environment may be utilized. Examples of workloads and functions which may be provided from this layer include: mapping and navigation; software development and lifecycle management; virtual classroom education delivery; data analytics processing; and transaction processing.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for collaborative messaging including natural delays, the method comprising:
receiving, by a computer, a message from a sender intended for a recipient using a collaborative messaging application;
determining, by the computer, message characteristics, sender characteristics, and recipient characteristics;
based on the determined message characteristics, sender characteristics, and recipient characteristics, dividing the message into one or more segments;
based on the determined message characteristics, sender characteristics, recipient characteristics and segment size, determining a time delay for each of the one or more segments; and
transmitting the message to the recipient one segment at a time, wherein successive segments are separated by the time delay corresponding to each segment.

2. The method of claim 1, wherein the message characteristics comprise message content, grammar and punctuation including the presence of periods, paragraphs indicators, special characters, capital letters, URLs, media, and emoticons.

3. The method of claim 1, wherein the sender characteristics and the recipient characteristics comprise a profile, a typing speed, typing habits, estimate of availability, a location, a device type, or calendar entries.

4. The method of claim 1, further comprising:
automatically providing a typing indicator visible to the recipient during the time delay between transmission of successive segments to simulate the sender typing the next segment.

5. The method of claim 1, further comprising:
learning sender's transmission characteristics; and
learning recipient's transmission characteristics.

6. The method of claim 1, further comprising:
modifying transmission of the message based on receiving a response from the recipient intended to the sender.

7. The method of claim 1, further comprising:
modifying transmission of the message based on the presence of a recipient typing indicator.

8. The method of claim 1, further comprising:
modeling time distribution between successive sends to learn various sender patterns and various recipient patterns.

9. The method of claim 1, further comprising:
pausing the transmission of a segment based on the recipient responding before all segments are transmitted.

10. The method of claim 1, further comprising:
canceling transmission of a segment based on the recipient responding before all segments are transmitted.

11. A computer system for collaborative messaging including natural delays, the computer system comprising:
one or more processors, one or more computer-readable memories, one or more computer-readable tangible storage devices, and program instructions stored on at least one of the one or more storage devices for execution by at least one of the one or more processors via at least one of the one or more memories, wherein the computer system is capable of performing a method comprising:
receiving, by a computer, a message from a sender intended for a recipient using a collaborative messaging application;
determining, by the computer, message characteristics, sender characteristics, and recipient characteristics;
based on the determined message characteristics, sender characteristics, and recipient characteristics, dividing the message into one or more segments;
based on the determined message characteristics, sender characteristics, recipient characteristics and segment size, determining a time delay for each of the one or more segments; and
transmitting the message to the recipient one segment at a time, wherein successive segments are separated by the time delay corresponding to each segment.

12. The computer system of claim 11, wherein the message characteristics comprise message content, grammar and punctuation including the presence of periods, paragraphs indicators, special characters, capital letters, URLs, media, and emoticons.

13. The computer system of claim 11, wherein the sender characteristics and the recipient characteristics comprise a profile, a typing speed, typing habits, estimate of availability, a location, a device type, or calendar entries.

14. The computer system of claim 11, further comprising:
automatically providing a typing indicator visible to the recipient during the time delay between transmission of successive segments to simulate the sender typing the next segment.

15. The computer system of claim 11, further comprising:
learning sender's transmission characteristics; and
learning recipient's transmission characteristics.

16. The computer system of claim 11, further comprising:
modifying transmission of the message based on receiving a response from the recipient intended to the sender.

17. The computer system of claim 11, further comprising:
modifying transmission of the message based on the presence of a recipient typing indicator.

18. The computer system of claim 11, further comprising:
modeling time distribution between successive sends to learn various sender patterns and various recipient patterns.

19. The computer system of claim 11, further comprising:
pausing the transmission of a segment based on the recipient responding before all segments are transmitted.

20. The computer system of claim 11, further comprising:
canceling transmission of a segment based on the recipient responding before all segments are transmitted.
